(19) United States
(12) Patent Application Publication
(10) Pub. No.: US 2007/0181195 A1
(43) Pub. Date: Aug. 9, 2007

(54) Switching mechanism

(76) Inventors: Eduard Burch, Wurenlos (CH); Marc Amsler, Kaisten (CH)

Correspondence Address: CERMAK & KENEALY LLP, 515 E. BRADDOCK RD, SUITE B, ALEXANDRIA, VA, 22314, US

(21) Appl. No.: 10/900,350

(22) Filed: Jul. 28, 2004

(30) Foreign Application Priority Data
Aug. 7, 2003 (DE) 103 36 165.0

(51) Int. Cl. F16K 11/074

(52) U.S. Cl. 137/625.46

(57) ABSTRACT

A mechanism (1) for switching at least two hydraulic tie-in points (5, 6, 7) between at least two switching positions includes a tie-in plate (2) and a switching plate (3). The tie-in plate (2) has at least two tie-in points (5, 6, 7). Each tie-in point (5, 6, 7) includes a flow opening (8) that penetrates the tie-in plate (2). Using fastening elements (4) the switching plate (3) can be fastened to the tie-in plate (2) in the at least two switching positions. The switching plate (3) has at least one recess (13) on its inside (12) and the inside (12) faces the tie-in plate (2) when mounted. In at least one of the switching positions the recess (13) connects at least two flow openings (8) of the tie-in points (5, 6, 7) with each other.

This application claims priority under 35 U.S.C. § 119 to German application number 103 36 165.0, filed 7 Aug. 2003, the entirety of which is incorporated by reference herein.

### BACKGROUND OF THE INVENTION

1. Field of the Invention

The invention concerns a mechanism for switching at least two hydraulic tie-in points between at least two switching positions.

2. Brief Description of the Related Art

A number of applications require hydraulic tie-in points to be arranged or blocked between two or more hydraulic tie-in points. To this end it is possible to use switching mechanisms as mentioned above. Such a switching mechanism as a rule can be designed as a valve in which the switching function instead of the throttle function, for example, is more important. A special application of such switching mechanisms is closed pipe systems, for example, in which a hydraulic medium circulates. The operation of such pipe or hydraulic systems can result in contamination, for example. Accordingly, it is necessary to flush the pipe system with a corresponding flush medium as required. A line of the pipe system can be opened at a suitable location of the pipe system. A switching mechanism as mentioned in the introduction can be connected to the resulting tie-in points. In a first switching position of the switching mechanism the two tie-in points of the line can communicate with each other so that the line and therefore the pipe system can function properly. In a second switching position the switching mechanism can connect at least one of the two tie-in points mentioned above with another tie-in point which allows introducing a suitable flushing medium into the pipe system. Since the flushing process intends to transport impurities out of the pipe system, the object is to have a switching mechanism that is not contaminated itself by the contaminated flushing fluid during the flushing process, because following the flushing process the flushing mechanism is switched back into the first switching position so that it becomes part of the pipe system again. Furthermore, it is desirable that the tie-in points of the pipe system are not exposed when they are switched back and forth but rather that the pipe system is always closed to the outside to prevent impurities from entering.

### SUMMARY OF THE INVENTION

The principles of the present invention address the issue of providing an improved embodiment of a switching mechanism as described in the introduction that above all does not get contaminated easily, can be switched without opening the tie-in points and has a comparatively inexpensive design.

Aspects of the present invention are based on the general concept of designing the switching mechanism with the help of a tie-in plate that carries the tie-in points and a switching plate that has at least one recess on the inside that faces the tie-in plate and that can be attached to the tie-in plate in the various switching positions, with the recess of the switching plate causing the desired switching of the tie-in points of the tie-in plate in the respective switching position. The switching mechanism in accordance with the invention therefore has an extremely simple but quite robust design. Since the switching mechanism in accordance with the invention achieves different switching positions based on different relative positions between the plates when they are fastened, the switching mechanism in accordance with the invention does not need any mobile or adjustable switching elements or similar elements within the hydraulic stream. This avoids the necessity of having areas in which impurities can easily accumulate such as edges of switch components or similar elements. This means the switching mechanism is not as prone to contaminant deposits. Furthermore, the switching mechanism can easily be designed for very large pressure values without any super-proportional expenses or efforts. The simple but robust design furthermore ensures that the switching mechanism is not subject to much wear so that it is characterized by an especially long service life

According to an advantageous embodiment, fastening elements that are used to fasten the two plates to each other can be in the form of screws that can be placed into holes on one plate and thread openings on the other plate into which the screws can be screwed. In accordance with the invention the holes and the thread openings are arranged in a manner that ensures that they can be used in at least two of the switching positions in order to fasten the plates to each other. This makes it possible to use the same thread openings and holes for at least two different relative positions between the plates for fastening the plates to each other, which simplifies the design of the switching mechanism. Furthermore this prevents mistakes during mounting which means the switching mechanism is especially reliable.

The design of the switching plate can be such that an as a rule random spatial change to the position of the switching plate results in different switching positions. For example, the switching plate can be a double-sided plate that has a first recess for the first switching position on one side and a second recess for the second switching position on the other side. Preferred, however, is an embodiment in which the switching plate must be rotated with regard to a longitudinal center axis of the switching mechanism in order to set the different switching positions.

According to an especially advantageous improvement the switching plate can be fastened in a rotating manner to the tie-in plate around the longitudinal center axis of the switching mechanism. When the fastening elements are released, it then is possible to switch between the two switching positions. In this embodiment the switching plate is fastened axially and radial to the tie-in plate during the rotation. This ensures that the tie-in points of the switching mechanism are not opened to the outside during the switchover, which prevents dirt from penetrating the tie-in points.

According to a different advantageous embodiment, one of the plates, preferably the switching plate, can have a cylinder-shaped circumferential section with regard to a longitudinal center axis of the switching mechanism with this section having a guide groove or guide collar in circumferential direction that interacts with at least one guide pin attached to the other plate, i.e., preferably the tie-in plate, in a manner that ensures that the guide pin, when the switching plate is rotated relative to the tie-in plate around the longitudinal center axis, makes contact with an circumferential end of the guide groove or guide collar when the switching board is in one of the switching positions. The guide pin and the interacting guide groove or guide collar thus form a rotational stop that limits the rotational adjustments of the switching plate in a manner that ensures that the two adjustable end rotational positions of the switching plate correspond to the two switching positions of the switching plate. This considerably simplifies finding the correct relative position between the two plates. This simplifies mounting and the proper function of the switching mechanism is improved.

Other important characteristics and advantages of the switching mechanism in accordance with the invention are disclosed in the drawings and the respective descriptions of the Figures based on the drawings.

### BRIEF DESCRIPTION OF THE DRAWINGS

The drawings show a preferred exemplary embodiment of the invention and are explained in more detail in the description below. Identical reference numerals refer to the same or similar or functionally identical components. The figures, schematically, show the following:

FIG. 1 shows a top view of a switching mechanism in accordance with the invention based on the arrow in FIG. 2,

FIG. 2 shows a longitudinal section through the switching mechanism based on sectional lines II in FIG. 1.

### DETAILED DESCRIPTION OF EXEMPLARY EMBODIMENTS

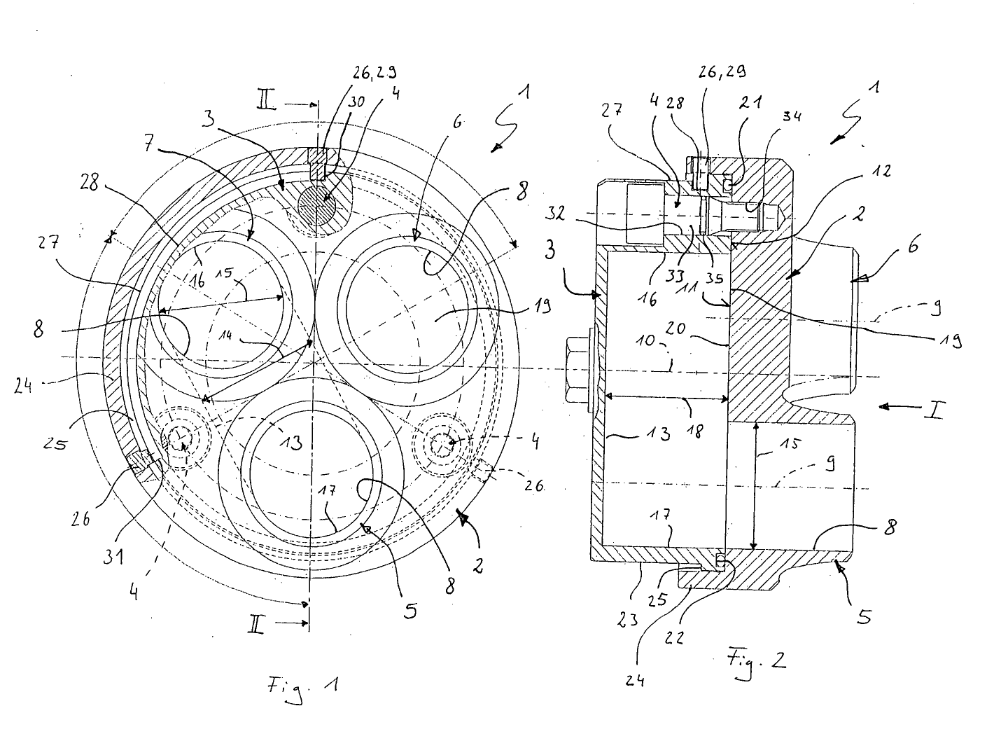

According to FIGS. 1 and 2 a switching mechanism 1 according to the invention has a tie-in plate 2 and a switching plate 3. The two plates 2, 3 can be fastened to each other or attached to each other as shown in the mounted state here using fastening elements 4.

In the exemplary embodiment shown, the tie-in plate 2 has three hydraulic tie-in points, a first tie-in point 5, a second tie-in point 6, and a third tie-in point 7. It is obvious that a different embodiment of the switching mechanism 1 can only have two or even four or more tie-in points. The number of tie-in points depends on the intended use for the switching mechanism 1. However, the number of tie-in points does not change the basic design.

Each tie-in point 5, 6, and 7 comprises a flow opening 8 that goes through the tie-in plate 2. It is practical for the flow openings 8 to have a cylinder shape, exemplarily a circular cylinder shape. The orientation of the flow openings 8 selected here is especially advantageous because it is such that the longitudinal axes 9 of the respective flow openings 8 are parallel with regard to each other and above all parallel with regard to a longitudinal center axis 10 of the switching mechanism 1. According to the exemplary embodiment shown, the arrangement of the individual tie-in points 5, 6, and 7 is such that the flow openings 8 are at a distance from the longitudinal center axis 10 but overall are concentric with regard to the longitudinal center axis 10 and optionally are evenly spread. Further optionally, all flow openings 8 have identical cross-sections at least on the inside of their mouths.

When mounted the tie-in plate 2 has an inside 11 that faces the switching plate 3 into which the flow openings 8 run and thus are open towards the switching plate 3. When mounted the switching plate 3 has an inside 12 that faces the tie-in plate 2 and in which a recess 13 is arranged. This means that the recess 13 is open with regard to tie-in plate 2.

The recess 13 is positioned and dimensioned to ensure that it connects the flow opening 8 of the first tie-in point 5 with the flow opening 8 of the third tie-in point 7 in the first switching position of the switching plate 3 shown in the Figures. The shape of the recess 13 is suitably such that there are as few dead water zones or backflow zones as possible when there is flow through the recess 13 through the flow openings 8 of the first and third tie-in points 5, 7. For example, the width 14 of the recess 13 is the same as the diameter 15 of the circular cylinder flow openings 8.

Furthermore, the longitudinal ends 16 and 17 of the recess 13 that belong to the respective flow openings 8 are adapted to the contour of the flow opening 8. In the example shown these longitudinal ends 16, 17 have a semi-cylinder contour whose radius corresponds to the radius of the flow openings 8 at their mouths.

Furthermore, it is practical to design the recess 13 keeping minimal flow resistance in mind. For example, the depth 18 of the recess 13 is identical to the diameter 15 of the mouths of the flow openings 8. Another improvement is possible, for example, by also rounding off the longitudinal ends 16, 17 of the recess 13 in reverse direction.

However, the decisive factor for the switching mechanism 1 in accordance with the invention is the fact that the flow area of the switching mechanism does not require any switching or actuator elements so that critical contours on or in which impurities could settle, can be avoided without much effort. Consequently, the switching mechanism 1 in accordance with the invention is especially unsusceptible to impurities.

As above all FIG. 2 shows, the design of the plates 2, 3 suitably is such that the inside 12 of the switching plate 3 has a flat contact contour 19 while the inside 11 of the tie-in plate 2 has a corresponding flat counter contact contour 20. When mounted, the areas of contact contour 19 and counter contact contour 20 are pushed against each other. The selected fastening method using screws 4 makes it possible to fasten the contact contour 19 and the counter contact contour 20 with comparatively high pressure forces, eliminating any play. This above all avoids the formation of gaps in which impurities could deposit.

In order to be able to seal the flow within the switching mechanism 1 to the outside, an axial seal 21, here in the form of an O-ring, is arranged between the insides 11, 12 of the plates 2, 3 that face each other when they are mounted. Optionally, one of the plates 2, 3, here switching plate 3, has a receiver groove 22 into which the seal 21 is placed.

In the embodiment shown here the switching plate 3 has a rotationally symmetrical outside contour 23 with regard to the longitudinal center axis 10. This makes it possible to rotate the switching plate 3 around the longitudinal center axis 10 to switch it between the switching positions, provided the fastening elements 4 are loosened. Accordingly, the tie-in plate 2 has a suitable retaining contour 24 that is developed radially on the outside of the tie-in plate 2 and extends in axial direction and protrudes over the inside 11 of the tie-in plate 2. The retaining contour 24 can be comprised of individual webs that are distributed at a distance from each other over the circumference. It also is possible to have retaining contours 24 by way of a collar that runs around the entire circumference. With the help of this retaining contour 24 the concentrically placed front end (inside 12) of the switching plate 3 is fixed to the tie-in plate 2 with a positive fit in radial direction. In order to additionally axially fasten the switching plate 3 to the tie-in plate 2, the switching plate 3, as is shown here, can have an annular step 25 at its front end. The tie-in plate 2 then has at least one, in this case three, retaining bolts 26 that radially support the step 25. The retaining bolts 26 are fastened to the retaining contour 24. The two plates 2, 3 thus are securely fastened to each other radially by the retaining contour 24 and axially by the step and the retaining bolts 26. To the extent the retaining bolts 26 do not provide for any radial bracing between the plates 2, 3, the two plates 2, 3 can be rotated with regard to each other along the longitudinal center axis 10, provided the screws 4 are removed. Accordingly, the switching plate 3 is pivoted or retained on the tie-in plate 2.

In the special improvement shown here the switching plate 3 is equipped with a guide groove 28 that runs along a circumferential section 27 with a limited angle and extends along circumferential direction. A guide pin 29 radially interacts with this guide groove 28. This guide pin 29 is attached to the tie-in plate 2, e.g., to its retaining contour 24. In the present case the guide pin is formed by a retaining bolt 26 that contrary to the other retaining bolts 26 is extended in radial direction to be able to engage with the guide groove 28. Groove ends 30 and/or 31 on the circumference limit the extension of the guide groove 28. The arrangement and dimensions of the guide groove 28 are such that the guide pin 29 rests on one of the groove ends 30, 31 in circumferential direction exactly when the switching plate 3 reaches one of its switching positions. Accordingly, the guide pin 29 in FIG. 1 rests on the groove end 30 that is part of the first switching position.

Instead of a guide groove 28 it also is possible to have another step that is limited in circumferential direction and that acts as a guide step. It also is possible to use other means that limit rotational movement and that limit the rotational movement of the two plates 2, 3 relative to each other in both rotational directions in both switching positions.

As mentioned in this case the switching plate 3 is fastened to the tie-in plate 2 with screws 4. For this purpose the switching plate 3 has a hole 32 for each screw 3 [sic] through which the shaft 33 of each respective screw 4 is pushed. Furthermore, the tie-in plate 2 has a thread opening 34 for each screw 4 into which the thread shaft 33 of the respective screw 4 can be screwed. Furthermore, the shaft 33 of the respective screw 4 has a radial seal 35 to seal the screw 4 to the outside. The holes 32 and the thread openings 34 are arranged in a manner that ensures that they can be used in at least two switching positions of the switching plate 3 to fasten the switching plate 3 to the tie-in plate 2. The holes 32 and 34 therefore are distributed evenly along the circumference. This design simplifies the structure of the switching mechanism 1.

The embodiment of the switching mechanism 1 shown here is like a 3/2-way valve that, based on the name 3/2, has three tie-in points 5, 6, 7 and two switching positions. The embodiment of the switching mechanism 1 shown in FIGS. 1 and 2 functions as follows:

FIGS. 1 and 2 show the first switching position of the switching mechanism 1 in which the recess 13 connects the flow opening 8 of the first tie-in point 5 with the flow opening 8 of the third tie-in point 7 so they communicate.

In the first switching position the recess 13 extends at a distance to the flow opening 8 of the second tie-in point 6. Accordingly, there is no communicating tie-in point between the recess 13 and the flow opening 8 of the second tie-in point 6. Rather, the flow opening 8 of the second tie-in point 6 is more or less tightly closed by the contact contour 19 of the switching plate 3.

In order to be able to switch the switching plate 3 from the first switching position into the second switching position, the screws 4 must first be removed. After the screws 4 are removed, the switching plate 3 can be rotated around the longitudinal center axis 10, i.e. clockwise with regard to FIG. 1. Since there are three tie-in points 5, 6, 7 that are distributed evenly in circumferential direction, the switching plate 3 can be rotated by 120° with regard to the tie-in plate 2. In this second switching position the holes 32 and the thread openings 34 are axially lined up, however, in a different combination than in the first switching position. The screws 4 then can be tightened accordingly. By turning the switching plate 3, the relative position of the recess 13 changes as well. In the second switching position the recess 13 is arranged in a manner that only the flow opening 8 of the third tie-in point 7 is connected to the flow opening 8 of the second tie-in point 6. The flow opening 8 of the first tie-in point 5 then is outside the recess 13 and thus is blocked by the flat contact contour 19 of the switching plate 3.

A major advantage of the switching mechanism 1 in accordance with the invention is the fact that the tie-in points 5, 6, 7 never must be opened to the outside to move the switching plate 3 from one switching position to another switching position. This prevents undesirable dirt from penetrating when the tie-in points 5, 6, 7 are opened.

Furthermore it is especially easy to open the switching mechanism 1 if maintenance or repair work is necessary. To this end first the screws 4 are removed. Then the retaining bolts 26 and/or the guide pins 29 are removed. Then the switching plate 3 can be axially removed from the tie-in plate 2.

Although the present invention is described here based on one embodiment in which the switching mechanism 1 is designed like a 3/2-way valve, the general application shall not be restricted to this particular embodiment. In particular, the switching mechanism 1 can also be designed like a 2/2-way valve in which the two tie-in points are connected via the recess in the first switching position while the two tie-in points are blocked in the second switching position. Furthermore, it is possible to design it like a 4/2-way valve in which the four tie-in points in the two switching positions can be switched accordingly.

### LIST OF REFERENCE NUMERALS

1 switching mechanism
2 tie-in plate
3 switching plate
4 fastening elements/screw
5 first tie-in point
6 second tie-in point
7 third tie-in point
8 flow opening
9 longitudinal center axis of 8
10 longitudinal center axis of 1
11 inside of 2
12 inside of 3
13 recess
14 width of 13
15 diameter of 8
16 longitudinal end of 13
17 longitudinal end of 13
18 depth of 13
19 contact contour of 3
20 counter contact contour of 2
21 axial seal
22 receiver groove
23 exterior contour of 3
24 retaining contour of 2
25 retaining step
26 retaining bolt
27 circumferential section of 3
28 guide groove
29 guide pin
30 groove end
31 groove end
32 hole
33 shaft of 4
34 thread opening
35 radial seal

While the invention has been described in detail with reference to exemplary embodiments thereof, it will be apparent to one skilled in the art that various changes can be made, and equivalents employed, without departing from the scope of the invention. Each of the aforementioned documents is incorporated by reference herein in its entirety.

1. A mechanism useful for switching at least two hydraulic tie-in points between at least two switching positions, the mechanism comprising:
a tie-in plate having at least two tie-in points, each tie-in point including a flow opening that penetrates the tie-in plate, the tie-in plate including a recess connecting at least two flow openings in at least one of the switching positions; and
a switching plate configured and arranged to be fastened to the tie-in plate in the at least two switching positions using fastening elements, the switching plate having at least one recess on an inside that faces the tie-in plate when mounted with the tie-in plate recess.

2. A switching mechanism according to claim 1, further comprising:
said fastening elements;
holes in the switching plate and in the tie-in plate, a plurality of said holes comprising thread openings;
wherein the fastening elements comprise screws configured and arranged to be placed into the holes of one of said switching plate and said tie-in plate and to be screwed into said thread openings of the other of said switching plant and said tie-in plate;
wherein the holes and the thread openings are configured and arranged to ensure that they can be used in at least two switching positions for fastening said plates to each other.

3. A switching mechanism according to claim 1,
wherein
the inside of the switching plate facing the tie-in plate comprises a flat contact contour;
wherein an inside of the tie-in plate facing the switching plate has a flat counter contact contour;
wherein the contact contour and counter contact contour surfaces touch when they are mounted together.

4. A switching mechanism according to claim 1, further comprising:
an axial seal configured and arranged to be positioned between the insides of the plates when they face each other when they are mounted.

5. A switching mechanism according to claim 1, wherein the at least two tie-in points, the flow openings of the at least two tie-in points, or both, at least in portions facing the switching plate, are at a distance from a longitudinal center axis of the switching mechanism and are concentrically distributed.

6. A switching mechanism according to claim 1, further comprising:
means for retaining the switching plate in a pivoting manner on the tie-in plate around a longitudinal center axis of the switching mechanism for switching between the at least two switching positions when the fastening elements are loosened.

7. A switching mechanism according to claim 1, further comprising:
at least one radial stop;
at least one guide pin;
wherein one of the plates has a cylinder-shaped circumferential section with regard to the longitudinal center axis of the switching mechanism, including said at least one radial stop;
wherein the at least one guide pin is attached to the other plate;
wherein the at least one radial stop and the at least one guide pin are configured and arranged to interact in the circumferential direction;
wherein the guide pin rests on the stop when the switching plate is rotated relative to the tie-in plate around the longitudinal center axis when the switching plate reaches one of its switching positions.

8. A switching mechanism according to claim 7,
wherein the circumferential section has a guide groove or a guide collar that extends in the circumferential direction;
wherein the at least one stop comprises a circumferential end of the guide groove or the guide collar.

9. A switching mechanism according to claim 1, wherein the depth of the recess corresponds to the diameter of the flow opening of one of the tie-in points.

10. A switching mechanism according to Claim 1,
comprising only two tie-in points and two switching positions; and
wherein the plates are configured and arranged so that the switching plate at least one recess is in flow communication with the flow opening of the two tie-in points in one switching position;
wherein the plates are configured and arranged so that the switching plate at least one recess is not in flow communication with any of the flow openings in the other switching position.

11. A switching mechanism according to claim 1
wherein the at least two tie-in points comprises only three tie-in points and two switching positions;
wherein the plates are configured and arranged so that the switching plate at least one recess is in flow communication with the flow opening of the first tie-in point and with the flow opening of the second tie-in point but not with the flow opening of the third tie-in point in the one switching position;
wherein the plates are configured and arranged so that the switching plate at least one recess is in flow communication with the flow opening of the second tie-in point and with the flow opening of the third tie-in point but not with the flow opening of the first tie-in point in the other switching position.

12. A switching mechanism according to Claim 1, wherein the switching plate at least one recess is configured and arranged to reduce flow resistance.

13. A switching mechanism according to Claim 1, wherein the switching plate at least one recess is configured and arranged to avoid dead water zones and backflow zones.

14. A switching mechanism according to claim 10, comprising a 2/2-way valve.

15. A switching mechanism according to claim 10, comprising a 3/2-way valve.
